(19) United States
(12) Patent Application Publication
(10) Pub. No.: US 2007/0106532 A1
(43) Pub. Date: May 10, 2007

(54) Planning of simultaneous examinations for a single patient within one time slot

(75) Inventors: Miguel Sigo, Gent (BE); Henk Vansteenkiste, Gent (BE); Wannes Kieckens, Gent (BE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: AGFA-Gevaert, Mortsel (BE)

(21) Appl. No.: 10/570,299

(22) PCT Filed: Sep. 13, 2004
(86) PCT No.: PCT/EP04/52150

§ 371 Date: Jan. 4, 2007

(30) Foreign Application Priority Data
Sep. 12, 2003 (EP) 03103382.2

(51) Int. Cl. G06Q 10/00

(52) U.S. Cl. 705/2

(57) ABSTRACT

The current invention is in the field of scheduling appointments for exams to be performed on patients in a clinical environment, where an appointment must be consistent with the availability of different resources, such as rooms, medical devices and medical or paramedical staff. An opportunity arises when two or more exams must be scheduled for one patient. These exams may be scheduled separately, however it may be possible that a first exam and other exams may be scheduled in one time slot. This depends on the compatibility of the first exam and the other exams and on the simultaneous availability of the resources, required for the first exam and the other exams. If the conditions are fulfilled, a plurality of exams may be combined in one time slot, and the scheduling systems has to schedule the first exam only, which scheduling is then valid for all other co-exams.

### FIELD OF THE INVENTION

The present invention relates to a method to schedule separate exams in appointments. More specifically the invention is related to a method of co-scheduling appointments.

### BACKGROUND OF THE INVENTION

In a clinical environment, a patient may need to undergo several exams. An exam may be a physical examination, a consultation, an exertion test, a blood test, a scan by a CT or MR scanner, an X-ray etc. Each exam may need specific resources, which availability has to be checked carefully, in order to schedule each exam. The process of scheduling may be time consuming for the operator.

The scheduling methods currently available provide means for scheduling appointments or individual exams consecutively. A procedure is then transformed in a set of appointments, by a scheduling process, by specifying a precise time for each exam in the procedure. For each exam the whole scheduling process has to be executed to obtain an appointment. In the cases where a patient has to have several exams, for each exam, independent of the resources to be used and time of performing, a separate appointment may need to be scheduled. The need exists for a method to co-schedule exams defined for e.g. different anatomical regions but which can be performed at one time slot with the same resources, because the first exam and other exams are compatible with each other. In a helical CT scanner, several portions of the body may be scanned, e.g. a scan of the brains, the heart, the thorax, abdomen. These portions may be further sub-divided in specific scans. A “total body scan” may comprise up to ten different CT scans. These exams may be executed virtually simultaneously, i.e. within one helical scan motion, and can be scheduled as if they are executed simultaneously. If each exam needs 5 minutes, then it may be possible to perform the total body scan in 10 minutes, instead of 10 times 5 minutes or 50 minutes. It is also important that these exams are planned as separate procedures, such that each planned procedure may receive a separate protocol drawn up by a specific radiologist.

### SUMMARY OF THE INVENTION

The above-mentioned effect is realised by the scheduling method having the specific features set out in claim 1 and by a system having the specific features set out in claim 10. Specific features for preferred embodiments of the invention are set out in the dependent claims.

Advantages and further embodiments of the present invention will become apparent from the following description and drawings.

### BRIEF DESCRIPTION OF THE DRAWINGS

FIGS. 1A and 1B show a flow diagram of the method according to the current invention.

### DETAILED DESCRIPTION OF THE INVENTION

While the present invention will hereinafter be described in connection with preferred embodiments thereof, it will be understood that it is not intended to limit the invention to those embodiments.

According to the present invention a scheduling method is provided which allows co-scheduling of appointments. The method allows to co-schedule exams defined for different or even similar anatomical regions but which may be performed at the same time slot with the same resources. Preferably, co-scheduling is done for exams for one single patient, if the co-scheduling of a first exam and an other exam is medically compatible, and if the resources required for the exams to be co-scheduled are common, equal or identical.

According to the invention, exams may be arranged in a batch. Each batch refers to one or more exams starting on a single day. One attribute of the batch may be the optional specification of a minimum or maximum time between the exams within the batch. For the first exam in the batch a start time is preferably specified. Although all the exams within a batch have to start on a single day, it is possible that one of these exams has a duration extending over two or more days. A batch may also contain just one exam.

Exams or batches may also be arranged in treatments. A treatment may be defined as at least two batches or even two exams or one exam and one batch, to be performed on at least two different days. One of the attributes of a treatment may be the specification a preferred period, when all exams within the treatment have to start. A period may be specified by a start date and an end date, or more informally by a specification such as “next week”, “the next 4 days” etc. A period specified by a start date and end date is more exactly referred to as a “date period”. Another attribute of a treatment is the recurrence of the batches. As such, one embodiment of a treatment is a batch with recurrence. In such case, the batch may be defined once, the multiplicity for this batch within the treatment is defined, e.g. 5, and the interval between the subsequent, substantially similar batches may be given as for example 4 days. A treatment with a recurrence of one, may degenerate in a batch having all exams starting on one single day.

One or more treatments or one or more batches or one or more exams may be arranged in a set, preferably to be executed on one service or department within a hospital.

A “procedure” is defined in this context as a request for an exam, one or more batches of exams or one or more treatments. A procedure requires the allocation of at least one resource for a certain duration of time. A resource typically refers to a room where the patient will be examined, a device for examining the patient or a required person. The required person may be a medical person such as a physician, a radiologist, an anaesthetist; or a paramedical person such as a nurse, a physiotherapist etc.

The term “procedure” is thus used to include an ‘exam’, a ‘batch’, a ‘treatment’ and a ‘set’. In most cases an exam within an order session is linked to one specific service or department, which may be the only department within the hospital where that specific exam may be performed. If the hospital or hospital association has several departments where the same exam may be performed, the prescribing physician may have the option to select freely one of the available departments. This may be achieved by linking to each specific exam type or exam code in the HIS or RIS system the single or several departments where this exam may be performed. In database systems, radiology information systems (RIS) or hospital information systems (HIS), each specific exam type may have a unique code, referred to as exam code, assigned to it. The RIS or HIS system preferably stores internally this code, but displays a human readable expression for the user of the information system, preferably in the language of the operator.

In cases where the exam may be performed in several departments, it may be possible to give the user one single most suitable option, to offer him the most suitable default with the option to change this choice or even to change this default, or to offer the user a completely free choice. If an exam has no pre-defined service linked to it, the user may have to select a specific service.

A prescribing physician, who prescribes one or more exams for a patient, may define an “order session”. An order session is a request for a procedure, such as an exam or batch or treatment, or a series of procedures. The order session may thus contain just one exam, or a plurality of exams, one or more batches or one or more treatments, optionally with a recurrence.

In an order session the procedures or exams are usually not specified with a precise start time for one or each of the exams. An order session may however specify a preferred period such as a period of two weeks, in which all the exams of the order session have to be performed. An order session may also specify the requirement that Mondays have to be excluded for the exams.

An order session may be transformed in a set of appointments, by a scheduling process. The scheduling process will specify a precise time for each exam in the order session.

The system according to the current invention may display a list of all procedures to be scheduled. Optionally the operator can use parameters such as the specification of a department, the specification of one order session or the specification of an order type to reduce the number of procedures displayed. A database, storing the order sessions and procedures, may assign an order type to each procedure, or more specifically to each exam. This order type may be used for restricting, also referred to as “filtering”, long lists of order sessions, procedures or exams. It is useful to have restricted lists for validating and scheduling. Also for selection of a first order session, it may be useful to browse through a restricted list, rather than through a full list of order sessions that have not been converted into appointments yet. This order type may be seen as a purely administrative code, e.g. for a CT scanner, an MR scanner, or an ultrasound (US) device. The database may provide that the hospitals are free to define the layout of such code, e.g. in the first characters they could code the name of the department, and in the following characters the specific type of exam, e.g. RAD_CT for a CT scanner in the RADiology department.

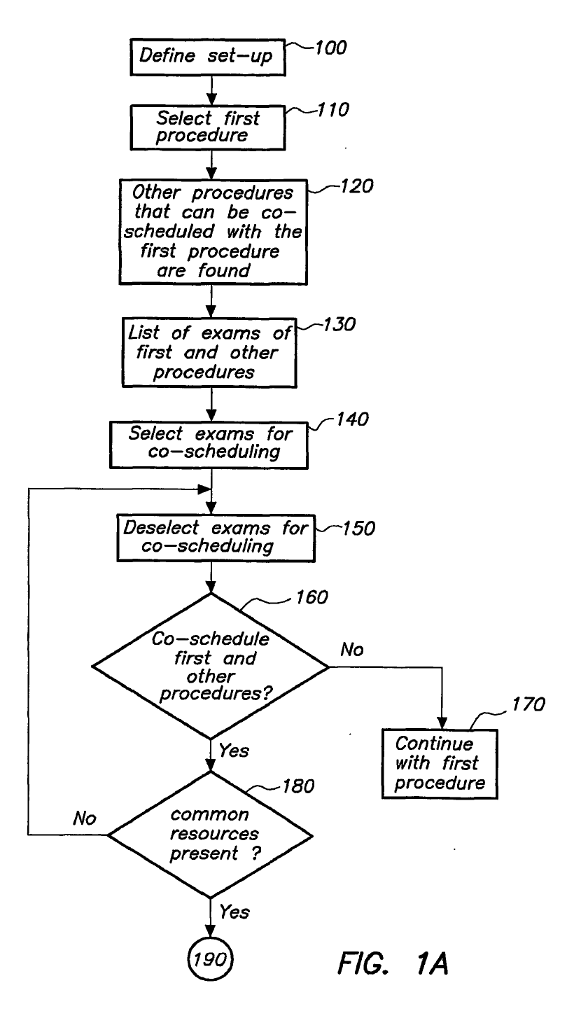

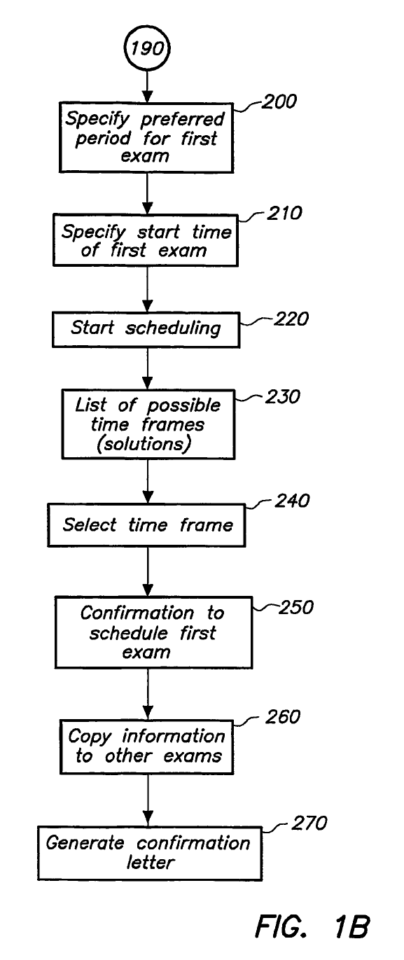

As shown in FIG. 1A, showing a specific embodiment of the invention, in a first step 100 it has to be defined in the set-up of the scheduling program which exams could be considered for co-scheduling. This may be considered as defining the “grouping relation”. Furthermore, according to specified criteria such as anatomical region to be examined, resources etc., the exams considered for co-scheduling, may be grouped or linked to each other. In the next step 110 the scheduling program is started to select a first procedure from a list of procedures. This list comprises exams that are not scheduled yet. The user may instruct the program to show those procedures or exams only that have at least one common resource. The resource may be a common CT scanner, or a common radiologist or a common room, or a common department. The operator may select one procedure or one exam from the procedures to schedule. The scheduling program checks in step 120 whether there exist other procedures for the same patient. If this is the case a list of exams of these procedures for this patient, that can moreover be co-scheduled, will be displayed. The criterion or criteria of whether a specific other exam can be co-scheduled with the first exam, or has a grouping relation with the first exam, has or have been preferably defined in the set-up step 100. According to step 130, the system then displays the list of exams of the first procedure, selected in step 110, and the other procedures found in step 120. According to step 140, the user then selects, from the list shown in step 130, the exams which he wants to co-schedule. Preferably, these exams are dragged from the list shown in step 130, to a list created in step 140. In step 150, the user may have the option to de-select exams, which he selected for co-scheduling in step 140, or which the system suggested in steps 120-130 for co-scheduling. The system will then ask the operator in step 160 if he wants to co-schedule the selected exams. If the user instructs the system not to co-schedule the exams, the system goes to step 170, where it continues to schedule the first procedure, selected in step 110. If the user instructs the system in step 160 to co-schedule the selected exams, the system goes to step 180 to check whether there are common resources present. This means the following. If there are 3 exams E1, E3 and E3, requesting the following resources R1, R2, R3 and R4:

E1: R1, R2, R3

E2: R1, R2, R3

E3: R1, R2, R4

then there is one resource R4 that is not common. In such case, the system will decide negatively in step 180 and give the user in step 150 the option to de-select an exam, in this case preferably E3, and to decide again on co-scheduling or not. Now, the resources required by the other exam(s), here E2 only, are also required for the first exam E1. It may be useful to select as “first exam” the exam that needs the most resources. If all the other exams, to be co-scheduled with the first exam, require only resources that are required in the first exam, it is possible to schedule the first exam only and be confident that the other exams can be scheduled together with the first exam, because they require no extra resources.

If on the other hand, the common resources are present according to step 180, the system will proceed with step 200 as shown in FIG. 1B. According to this step 200, the user or operator can specify a preferred time period for the first exam. This specification of the preferred time period for the first exam, for all other exams or procedures, could have been done also much earlier, at the time when the prescribing physician entered the exams in the system. A time period may be specified as a date period, i.e. a number of consecutive days, starting from a start date and ending at an end date. Such date period may be identified by giving the start date, e.g. 12 Sep. 2003 and an end date, e.g. 19 Sep. 2003. The date period may also be specified by giving a start date as above, and a number of days, e.g. 8 days for the above example. A date period may also contain a specification of exception days. For example, the date period may specify that weekend days, such as Sunday and/or Saturday are not allowed for scheduling or co-scheduling the exams. The date period may also be specified by a, preferably chronologically sorted, list of days. This list may show date gaps, e.g. 12, 15, 16, 17, 19 Sep. 2003. The date gaps are here 13, 14 and 18 September. A preferred period may also be specified as or may include a time period during one day. A time period may be identified by a start time, e.g. 9 a.m. and an end time, e.g. 5 p.m. This example may be noted as 09:00-17:00. Also a time period may specify one or more exception times, such as lunchtime between 12 a.m. and 1 p.m. A time period may also be a list of smaller, preferably chronologically sorted, time frames, with time gaps in between, e.g. 09:00-09:15; 10:00-10:15; 11:00-11:15; 13:00-13:15; 14:00-14:15; 15:00-15:15.

According to step 210, the operator or user may now specify a start time for the first exam. This first exam may be the chronologically first exam of the list of exams to be co-scheduled. The start time for the first exam may be given as a time interval, within which the first exam has to be started. E.g. the user may specify that the first exam has to start in the time interval 09:00-11:30.

Once the user entered the above-mentioned data, he may instruct the system in step 220 to start the scheduling process.

The system will search in step 230 on the common available time slots of the resources, required by the first exam, and the indicated time periods on which the exams may be scheduled. A list with possible time frames or time slots will be displayed in step 230 and the operator can select a time frame in step 240 to schedule the appointment. Preferably, the system shows in step 230 the time intervals which are available as a start time for the first exam. Once the user selects a specific point in time for starting the first exam, a time frame may be selected automatically according to step 240, possibly on the condition that the system keeps track of the duration of the first exam. In step 250, the user gets the option to confirm the scheduling of the first exam. After confirmation, preferably the other exams from the co-exam list, as created and approved in point 190 of FIGS. 1A and 1B, will be automatically scheduled on the same time frame wherein preferably all the information entered into the confirmation screen, will be copied to the other exams. If one of the exams has a different duration, it will preferably receive the duration of the first exam. This may be done in step 260, along with optionally copying all information from the (chronologically) first exam to the corresponding information data structures of the other co-scheduled exams. Such information may relate to clinical information, remarks about antecedents of the patient, etc. If each data structure has only one instance or occurrence, it may be necessary to overwrite the information data of the other exams with the corresponding information data of the first exam. In a preferred embodiment, the information records of the exams are kept as a single or double linked list, such that information data may be entered in that list, e.g. by concatenation. To insert information data from the first exam, a link for the other exam may be broken, and an information record is inserted between the broken ends, such that a new, longer linked list is created. The information data may then be copied in the information record, which may be a data structure.

In an optional step 270, the system may generate a confirmation letter for the patient. This letter may contain the name of the patient, the name of the prescribing physician(s), the first exam and related information and optionally information about the other exams, co-scheduled with this first exam. The confirmation preferably also displays the start time of the first exam. That confirmation letter may be prepared in electronic form and be stored in the system as e.g. a Word, XML or PDF file. This file may be printed on an inkjet, electrographic, impact matrix, daisy wheel or thermal printer. The printed form may then be sent in an envelope by regular mail to the patient or any other person such as the prescribing physician, or handed over to him. Alternatively, this form may be faxed to one of the above-mentioned persons. This electronic form may also be faxed directly from the system, or e-mailed to one of the above-mentioned persons. The fax may arrive at a mobile telephone set or a computer system linked to a mobile telephone. It is even possible to send the information about the co-scheduled exams in e.g. an SMS message to a mobile telephone set.

In a specific embodiment, possible warnings may be displayed in step 120 in case that one of the exams is already scheduled for this patient or in case that exams that can be co-scheduled with the selected exam are already scheduled. The operator may then decide to manually overbook on the time frame of one of these exams. The screen that has to be filled out to schedule an exam does not appear in this case but is copied from the exam that had already been scheduled. Overbooking is also possible in an ‘occupation-by-day’ screen showing the appointments of a specific physician. When selecting a co-exam of an exam that has already been scheduled, the operator will be able to force the other exams on the same time frame.

### EXAMPLE

We suppose that a patient has to undergo a CT examination. We suppose that the system defined the following available exams:

CTTO: A CT scan of a thorax

CTHA: A CT scan of a neck

CTHE: A CT scan of brains

The system has a list of all available exams, which may be as long as 200 types of CT scans. One exam may specify that it happens with a contrast medium, and another exam without a contrast medium. One exam has to be done by a high-resolution brand new CT system, whereas the other exam may be done by an older type of CT scanner, having a lower resolution. It is also possible to arrange exams in sub-exams. An exam for the CT scan of a hand, may have three sub-exams such as left hand, right hand and left+right hand.

The system may also give the operator the option to define in a set-up which exams may be co-scheduled with another exam. It is also possible to define that a certain exam must never be co-scheduled with a specific other exam, or a range of several other exams. E.g. the system may specify for the exam CTTO, that it may be co-scheduled with the exams CTHA and CTHE. Also for CTHA, it may be specified that it may be co-scheduled with CTTO and CTHE. But, for CTHE, the system may be set-up in step 100 of FIG. 1A that CTHE can only be co-scheduled with CTHA, because e.g. the X-ray dose for CTHE is much lower than the required dose for CTTO. As such, in this example the following grouping relations are defined:

1. CTTO with CTHA and CTHE;

2. CTHA with CTTO and CTHE; and

3. CTHE with CTHA.

As such, for each exam, the system may keep a list of exams that may be co-scheduled with that exam, preferably defining a grouping relation.

It is also possible to define that e.g. CTTO can be co-scheduled with a full class of other CT scans, where the class is or represents a set of other CT scans, or more generally other exams. As such the user can select CTTO, and for CTTO make a selection from all other exams, in order to include CTHA and CTHE in the list of exams that may be co-scheduled with CTTO.

In the set-up of the system of step 100, it may be necessary to define or set specific system parameters, which allow co-scheduling or which allow other special scheduling methods, such as simultaneous scheduling, as described in EP 03 102 683.4, filed on 1 Sep. 2003. If both simultaneous scheduling and co-scheduling are available, the system preferably gives the user first the option to select for co-scheduling according to the current invention, and then the option for simultaneous scheduling.

The first procedure that is selected in step 110, for this example CTTO, may have been defined earlier in an order system for procedures or exams. Each procedure may contain already an indication of a preferred date period and/or a preferred time period. In step 100, the user may first restrict the procedures shown on the screen to those that relate to a specific CT scanner or a set of CT scanners. Alternatively, the user may restrict the display to all exams for a specific patient or all exams or procedures for a specific department, e.g. the radiology department. In step 120, the system checks whether there are other procedures for this patient, in this example CTHA and CTHE, and gives preferably a separate warning if there are procedures or exams for this patient that have been scheduled already. In step 130, the exams of the first and other procedures are listed, here CTTO, CTHA and CTHE, and in step 140 the user selects the exams that may be co-scheduled, e.g. CTTO, CTHA and CTHE optionally followed by a de-selection step 150. If the user selects in step 160 to co-schedule the selected exams, the system preferably checks whether the selected exams have common resource groups, and whether the resources within the resource groups are common. Suppose that exam CTTO requires as resource CT-room number 5. The resource group is then “CT-room”. Suppose that CTHA requires as resource CT-room number 7. The resource group for CTHA is then also “CT-room”. As such, the resource groups for CTHA and CTTO are compatible, and these two exams are further checked for compatible resources, which is not the case in this example because room 5 is different from room 7. The resource groups are compatible if the intersection of the set of resource groups of the first exam and the set of resource groups of the other exams is not empty.

According to another example, the following resource groups may be defined:
1. For the exam type CT-Thorax the resource group “CT old rooms” having CT1, CT2, CT3
2. For the exam type CT-Heart the resource group “CT new rooms” having CT4, CT5, CT6
3. For the exam type CT-General, the resource group “CT all rooms”, having CT1, CT2, CT3, CT4, CT5, CT6.

An exam CT-thorax can not be co-scheduled with an exam CT-heart, because the intersection of the resources within the associated resource groups is empty. However, it is clearly possible to co-schedule a CT-General with a CT-Heart, because the intersection is now CT4, CT5 and CT6. It is thus clear that it is not necessary that the resource group is identical. However, the intersection of the resource groups associated with the first exam and the other exam or exams is preferably not empty. If the intersection is empty, this may be undone by de-selecting an offending exam, which introduces a resource not available in the first exam. Preferably the other exam or other exams require never more resource groups or resources than the first exam. Alternatively, the other exam or exams preferably need an equal number or less resources as the first exam.

More preferably, the resource groups of the other exams are a subset of the resource groups of the first exam. The concept of subset includes the possibility that the two sets are equal or identical. According to the subset principle, the co-exams, i.e. the other exams must not have more resource groups than the first exam. If this condition is fulfilled, it is possible to schedule the resources and patient for the first exam only, and be confident that the scheduled solution is then also compatible with the other exams. Each time slot in the solution preferably guarantees that the required resources are simultaneously available for that patient during that time slot.

In step 200, shown in FIG. 1B, the user may specify a preferred period for the first exam, however this may have been done already in the ordering procedure.

In step 210, the user may specify the start time of the first exam, and the scheduling process may start in step 220. The system now searches for a solution, fulfilling the required resources. In a preferred embodiment, the other exams do not need resources, which are not required for the first exam. As such, the scheduling process can be confined to searching for a solution, taking into account the requirements of the first exam only. Once the scheduling process found one, some or all available time slots for planning the first exam, the user has according to step 240 the possibility to select a suitable time frame, from the list of available time frames shown in step 230.

Having described in detail preferred embodiments of the current invention, it will now be apparent to those skilled in the art that numerous modifications can be made therein without departing from the scope of the invention as defined in the appending claims.

1. A method for grouping a plurality of exams for a patient comprising the following steps:
selecting a first exam;
selecting at least one other exam, related to said first exam;
is characterised in that the method further comprises the step of defining a grouping relation between said first exam and said other exam.

2. The method according to claim 1, further comprising the steps of:
listing a plurality of exams, having said grouping relation;
selecting said first exam and said other exam from said plurality of exams; and,
optionally selecting or de-selecting extra exams from said plurality of exams.

3. The method according to any one of the previous claims, further comprising the steps of:
assigning to said first exam at least a first resource;
assigning to said other exam at least a second resource;
checking whether said second resource has been assigned to said first exam.

4. The method according to any one of the previous claims, further comprising the step of assigning to said first exam or to said other exam a preferred date period or a preferred time period.

5. The method according to any one of the previous claims, further comprising the step of assigning to said first exam or to said other exam a start time or a time interval for starting the exam.

6. The method according to any one of the previous claims, further comprising the step of scheduling an appointment for said first exam only and using said appointment for said other exam.

7. The method according to any one of the previous claims, further comprising the step of copying information from said first exam to said other exam.

8. The method according to any one of the previous claims, comprising the step of generating a confirmation letter for said first exam said confirmation letter comprising optionally information for said other exam.

9. The method according to the previous claim, comprising the step of transmitting said confirmation letter by a device selected from the group consisting of a fax, a telephone, a mobile telephone, a printer.

10. A system for grouping a plurality of exams for a patient comprising:
means for selecting a first exam;
means for selecting at least one other exam, related to said first exam;
is characterised in that the system further comprises means for defining a grouping relation between said first exam and said other exam.
